(19) United States
(12) Patent Application Publication
(10) Pub. No.: US 2010/0166430 A1
(43) Pub. Date: Jul. 1, 2010

(54) Broadcast optical interconnect using a MEMS mirror

(76) Inventor: Steve Alten, Hillsboro, OR (US)

Correspondence Address: JOHN BRUCKNER PC, P.O. BOX 17569, SUGAR LAND, TX, 77496-7569, US

(21) Appl. No.: 12/317,604

(22) Filed: Dec. 26, 2008

(51) Int. Cl. H04B 10/00

(52) U.S. Cl. 398/135

(57) ABSTRACT

Methods and apparatus are described for optical interconnection. A method includes reconfiguring a free space broadcast interconnection including repositioning a micro electromechanical system mirror. An optical interconnect system comprises: at least two processing elements, each of said processing elements comprising: at least one optical signal transmitter; at least one optical signal receiver on the same support structure as the transmitter; and at least one MEMS mirror to provide the capability of optically connecting the emitter and transmitter.

### BACKGROUND INFORMATION

1. Field of the Invention

Embodiments of the invention relate generally to the field of optical interconnects for computer systems and/or their subsystems as well as networks and/or their subsystems. More particularly, embodiments of the invention relates to MEMS (micro electro mechanical system) mirror enhancements to a free-space optical interconnect that includes a fan-out and broadcast signal link.

2. Discussion of the Related Art

High performance interconnection of distinct computing elements is required to unleash the potential of parallel computing. Many of today's interconnect technologies can experience significant performance degradation under high data traffic loads, which is when you need the interconnect to perform best. Typical cable-based interconnect communication protocols can often add cumulative latencies for each packet of communication. A cable-based interconnect will typically hit performance bottlenecks before it reaches the aggregate bandwidth limit of its communication fabric due to data packet formatting overhead, multi-access protocols and/or cabling induced noise. The use of data-carrying light in a free-space, broadcast optical interconnect offers the promises of external cable elimination, much higher data transfer bandwidths, and/or one-to-one or all-to-all communication without incurring incremental latencies.

The construction of a broadcast optical, free-space, interconnect for parallel computing offers significant challenges due to the precise manufacturing tolerances required. These tolerances are further exacerbated by real world usage of the interconnect that may include vibration, shock and temperature variations. An optical interconnect that can align, repair and reconfigure itself due to unforeseen requirements or fluctuating performance demands would be highly desired.

Cho, et al. U.S. Pat. No. 7,095,548 describes a micro-mirror array lens with free surface and reproduces a predetermined free surface by controlling the rotation and/or translation of the micro-mirrors.

Dress, et al. US Patent Application Publication No. 2004/0156640 describes an optical fan-out and broadcast interconnect. Dress, et al. US Patent Application Patent Publication No. 2004-0156640 describes an n-Way, serial channel interconnect that comprises a means of effecting a non-blocking, all-to-all, congestion-free interconnect for communicating between multi- or parallel-processing elements or other devices requiring message coupling.

What is need is an approach to provided a non-blocking, all-to-all congenstion-free interconnection that adds incremental functionality, reduces manufacturing complexity, automates manual alignment processes and improves reliability through self healing capabilities. Heretofore, these needs have not been satisfied.

### SUMMARY OF THE INVENTION

There is a need for the following embodiments of the invention. Of course, the invention is not limited to these embodiments.

According to an embodiment of the invention, an optical interconnect system comprises: at least two processing elements, each of said processing elements comprising: at least one optical signal transmitter; at least one optical signal receiver on the same support structure as the transmitter; and at least one MEMS mirror to provide the capability of optically connecting the emitter and transmitter. According to another embodiment of the invention, a method comprises: reconfiguring a free space broadcast interconnection including repositioning a micro electromechanical system mirror.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 illustrates free space optical interconnect appropriately labeled “PRIOR ART.”

FIG. 2A illustrates distinct mapping of reflected light beams distributed across the surface of a MEMS mirror representing an embodiment of the invention.

FIG. 2B illustrates marginal areas of signal quality between adjacent reflected light beams representing an embodiment of the invention.

FIG. 2C illustrates the redirection of marginal quality light beams to a light sink with a MEMS mirror representing an embodiment of the invention.

FIG. 3A illustrates the front view of a single transmitter reflecting off a mirror out of alignment with a receiver representing an embodiment of the invention.

FIG. 3B illustrates the side view of a single transmitter reflecting off a mirror out of alignment with a receiver representing an embodiment of the invention.

FIG. 3C illustrates the front view of a MEMS mirror to facilitating the alignment of a single transmitter and receiver representing an embodiment of the invention.

FIG. 3D illustrates the side view of a MEMS mirror to facilitating the alignment of a single transmitter and receiver representing an embodiment of the invention.

FIG. 4A illustrates unutilized spare optical receivers representing an embodiment of the invention

FIG. 4B illustrates the use of a MEMS mirror to redirect a transmission to a spare receiver representing an embodiment of the invention.

FIG. 4C illustrates unutilized spare optical transmitter representing an embodiment of the invention.

FIG. 4D illustrates the use of a MEMS mirror to redirect a spare transmitter to the appropriate receiver representing an embodiment of the invention.

FIG. 5A illustrates the use of a MEMS mirror to eliminate a spreading lens in an optical interconnect representing an embodiment of the invention.

FIG. 5B illustrates the use of a MEMS mirror to eliminate a splitting lens in an optical interconnect representing an embodiment of the invention.

FIG. 5C illustrates a transmitter array of collimated light and the use of a MEMS mirror to eliminate multiple static lenses in an optical interconnect representing an embodiment of the invention.

FIG. 6 illustrates the use of MEMS mirrors to facilitate alignment of free-space multiple optical interconnects representing an embodiment of the invention.

FIG. 7 illustrates the use of a MEMS mirror to facilitate the splitting of an optical broadcast transmission to multiple receivers representing an embodiment of the invention.

FIG. 8 shows the preferred embodiment of the invention's advantages representing an embodiment of the invention

FIG. 9 shows a spare MEMS mirror that can be electro-mechanically swapped out with a failed MEMS mirror representing an embodiment of the invention.

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The invention and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

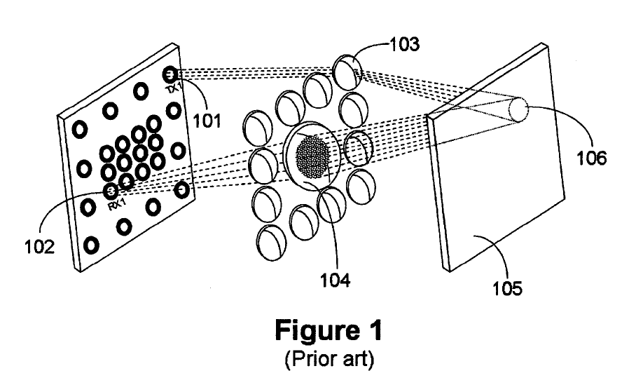

US Patent Application Publication No. 2004/0156640 FIG. 1 describes how an optical transmitter or emitter 101 can broadcast a data-encoded free-space light beam through a spreading lens 103, bounce 106 it off a mirror 105, back to a focusing lens 104, to a specific optical receiver 102. The alignment of the lenses and mirror 101, 102, 103, 104 and 105 must be very precise and constructed in such a way to avoid communication degradation or failure due to vibration, shock or temperature drift.

This invention describes a plurality of advantages for a run-time repositionable Micro Electro Mechanical Systems (MEMS) mirror replacing the functionality provided by the statically positioned mirror 105 in a free-space, broadcast optical broadcast interconnect. The invention can enhance functionality of the statically positioned mirror FIG. 1 105 in the modular, optical broadcast interconnect described in US Patent Application Publication No. 2004/0156640. The run-time repositionable MEMS mirror enhances this prior art by adding incremental functionality, reducing manufacturing complexity, automating manual alignment processes and improve reliability through self healing capabilities.

Due to the high communication data rates supported by the intended use of this optical broadcast interconnect, repositioning any of the MEMS mirror elements would likely be disruptive during the free-space optical interconnect's operation. Typical use of the repositionable MEMS mirror capability would only be done during power-up initialization, offline diagnostics or in response to a run-time communication failure that required a mirror adjustment. The positioning of the MEMS mirror would need to be finely adjustable through an applied voltage or other electric means and is required to statically maintain its position or shape without moving during routine optical communication use. Future advances in MEMS mirrors are expected and this invention is intended to work on newer mirror technologies as well as the current ones. There are two families of MEMS mirror available at the time of this invention and both are applicable to this invention.

The first category of MEMS mirror is known as Deformable Mirror (DM) or Micro-machined Membrane Deformable Mirror (MMDM). DMs or MMDMs can have thousands of linear actuators attached to the base and tensioned through a spring. The actuators are controlled though an electrostatic electrode attached to a highly reflective nano-laminate membrane that can be adjusted to a very high level of control. DMs and MMDMs have the advantage of maximizing the reflected light as there aren't any spaces between the mirror elements, but have the potential of slightly affecting its nearest neighbor optical reflection characteristics during extreme swings in the stroke length of the mirror position actuator. The nearest neighbor issue can be dealt with through greater spacing between reflected signals using the DM or MMDMs. The total number of reflected beams would likely be reduced as a result of the increased spacing requirements.

The second category of micro mirror arrays is known as Digital Micro-mirror Device (DMD). DMDs can be a single axis mirror array like Digital Light Processor (DLP) or utilize dual axis mirror arrays. Many single axis DLPs do not support fine adjustment of the actuators affecting the mirrors orthogonal pitch and roll relative to the plane of the base, in favor of a binary choice of maximum or minimum angle choice. The use of a finely adjustable single axis micro-mirror array would be possible to use for much of this invention, but not as generally useful as a dual axis micro-mirror array which can reflect light in a more controllable X-Y grid on the receiving plane. A dual axis micro-mirror array with finely adjustable actuators controlling the orthogonal reflection of each mirror element in an X and Y space would be incorporated in the preferred embodiment of this invention.

A number of the key details of this invention utilizing a MEMS mirror are listed below:

1. Multiple, Optically-Based Communications Sharing a Single MEMS Mirror Array

The modular, optical broadcast interconnect described in US Patent Application Publication No. 2004/0156640 FIG. 1 uses a statically positioned mirror 105 to bounce light based communications from co-planar emitters 101 to receivers 102. Sharing of the locations where the signals bounce 106 off the mirror isn't an issue for the static mirror because light is inherently non-blocking and the receivers and transmitters are spread out to take advantage of the orthogonal reflection characteristics.

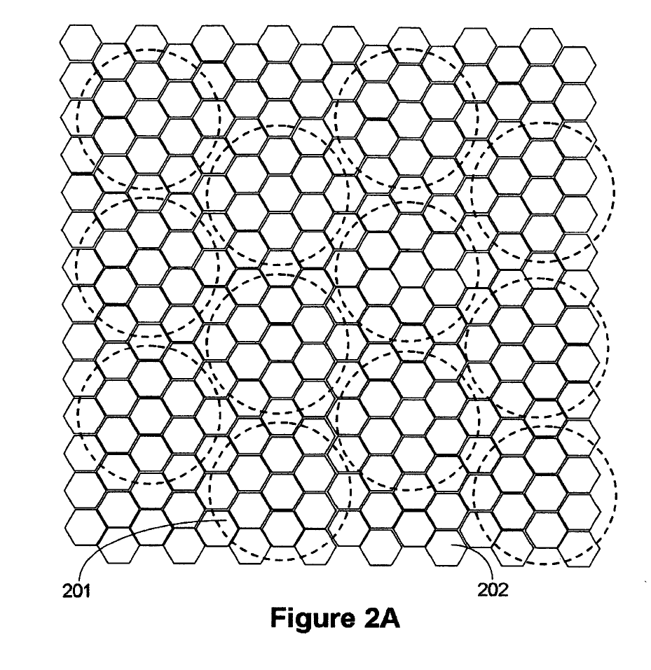

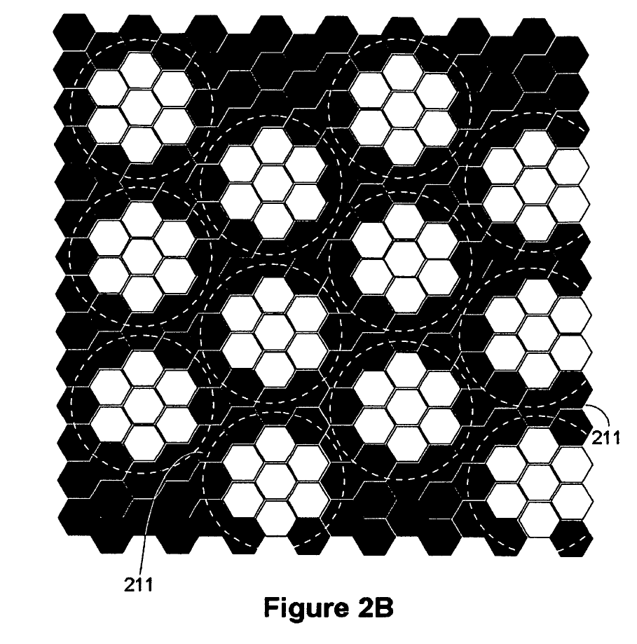

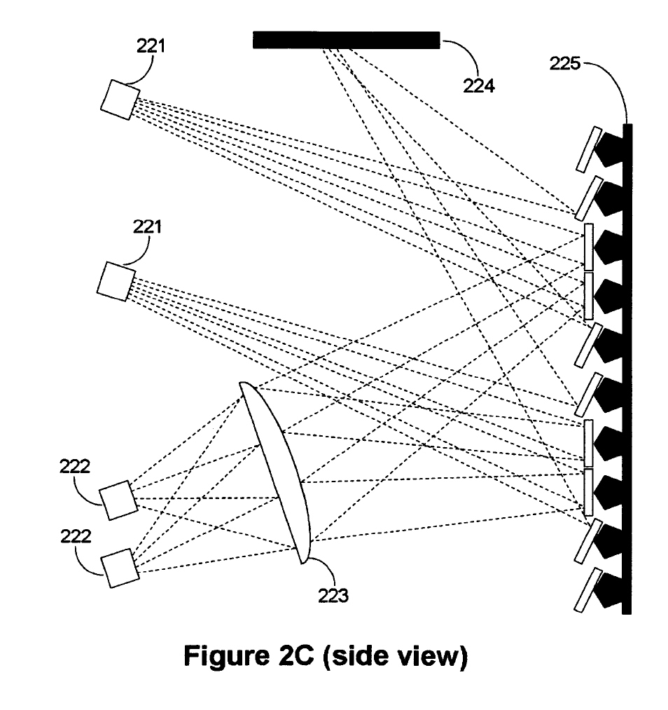

The repositioning of the MEMS mirror during actual operational use of the system could cause unintended modification of multiple optically-based communication streams. Therefore, each unique communication path would ideally utilize a reserved part of the MEMS mirror FIG. 2A so each optically-based communication can be individually redirected. Areas of adjacency of these signals can potentially crowd 211 or even overlap with their nearest neighbor FIG. 2B. These peripheral areas of questionable signal quality coming from emitters 221 can be redirected with a MEMS mirror 225 to a non-reflective light sink 224 and therefore be considered discarded FIG. 2C. The portion of the reflected signals considered good can be redirected by the MEMS mirror 225 to the receivers 222 through a focusing lens 223.

In FIG. 2A non-overlapping spacing 201 of these optical transmissions across the surface of the MEMS mirror will be influenced by the size of the collimated light beam striking the MEMS mirror elements 202. A larger reflective surface area of light may be needed if multiple MEMS mirror elements are required to modify the reflected optical transmission.

2. Optical Signal Cleanup

The periphery of an optical signal can have poor integrity due to proximity to other light based signals FIG. 2B 211 or unwanted random light diffusing from lens inaccuracies. Re-direction of marginal quality portions of communication light beams to a light sink FIG. 2C 224 will reduce receiver confusion from random ambient light.

3. Automated Optical Alignment with a MEMS Mirror

Alignment of the optical emitters, optical receivers, spreading lenses and focusing lenses can be a challenging manufacturing exercise. Replacement of failed components in the field may require extraordinary manufacturing tolerances to insure compatibility or alternatively, manual adjustment of the optical interconnects components by a technician. If an optical communication becomes out of alignment due to environmental factors such as vibration, shock or temperature variation, a statically aligned optical interconnect can partially or completely fail. This is especially a concern for lights-out installations, embedded designs or unmanned deployments such as in a space based satellite. A large broadcast optical interconnect with tens, hundreds or thousands of concurrent optical communication paths greatly complicate manufacturing and alignment.

The use of a MEMS mirror to steer the reflection of an emitter to the appropriate receiver would greatly simplify the construction of an optical broadcast interconnect and allow less precise placement of components and eliminate the requirement for manual tuning during the manufacturing process. Automated optical alignment can also be very useful for keeping a deployed system up and running when an optical communication misalignment occurs.

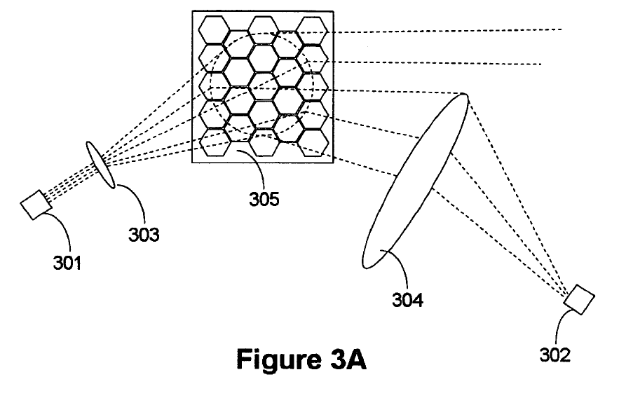

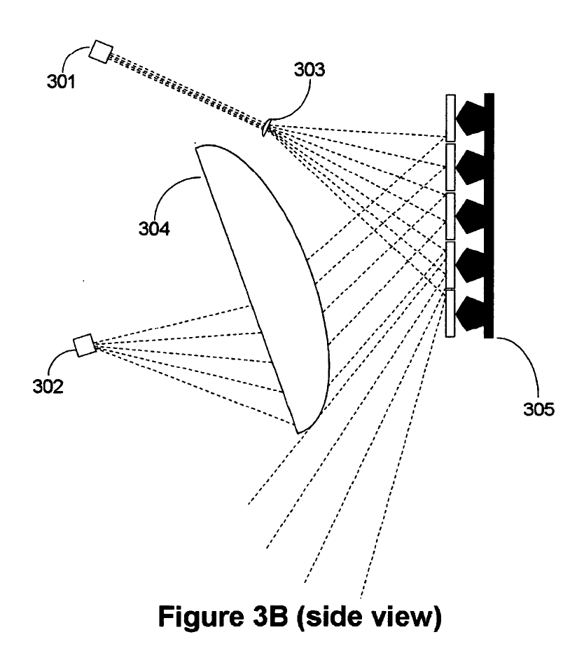

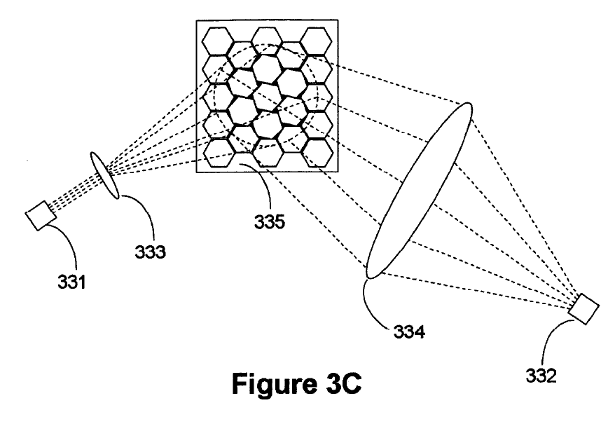

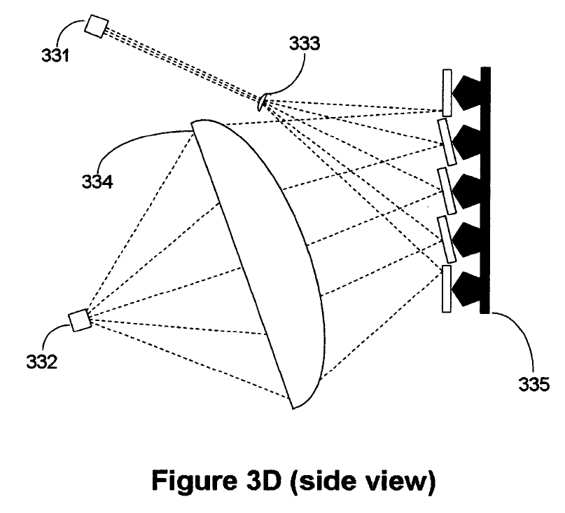

As shown in FIGS. 3A & 3B, the communication signal integrity can be evaluated by the strength of the signal being received. If an optical emitters 301 output after going through the spreading lens 303 and reflecting off the MEMS mirror array 305 through the focusing lens 304 is partially reaching or not reaching a receiver 302, the signal amplitude will be lower than expected. If an optical communication path signal quality is below a definable threshold, adjustments to the illuminated area of the MEMS mirror array can be performed to steer the light beam through the focusing lens 304 and accurately target the receiver 302 to improve the optical signal amplitude.

Repositioning FIGS. 3C and 3D MEMS mirror 335 illuminated mirror elements can be table based for coarse adjustment with finer adjustment based on real-time feedback provided by the resulting signal quality change Small increments of the MEMS mirror array's orthogonal pitch and roll, resulting in a corresponding X and Y steering of the light beam at the receiving plane will either improve or degrade the signal amplitude coming from the emitter 331 through the spreading lens 333. A simple algorithm mapping greatest signal improvement for both the X and Y adjustments will allow the MEMS mirror to be optimally positioned.

If the coarse adjustment of an optical transmission doesn't result in at least a poor quality signal in the targeted receiver, all other non-targeted receivers could be interrogated to watch out for a potentially errant optical transmission and the MEMS mirror elements can implement an expanding circle sweep to utilize the receiver plane to look for the lost signal. If a non-target receiver gets the signal, it can utilize the table-based coarse adjustment with relative offsets to itself to reposition the MEMS mirror to the targeted receiver 332 through the focusing lens 334 and further finer adjustments can be made with real-time signal strength feedback.

4. Broadcast Optical Interconnect Component Failover Support

In a high availability system that requires a huge percentage of uptime, auto detection of errors and self healing is often required to achieve 99.999% (also known as five-9) or 99.99999% (also known as seven-9) reliability targets. Total redundancy of all possible failure points can quickly result in doubling the cost of materials and doesn't adequately support continued operation if the designated redundant, failover part is also becomes non-operational. A better solution would be to have a pool of unassigned failover components than can be flexibly remapped as replacements for components that fail and maximize the amount of time before failing subassemblies need to be replaced. Ideally, a broadcast optical interconnect allows for real-time self healing through swapping of unused optical communication paths for failed ones and the software to remaps the replacements in place of the failed subassemblies.

A broadcast, optical interconnect inherently offers natural node communication failure determination, but a MEMS mirror adds the capability of automated, flexible self healing. In the case wherein a communication failure and the realigning of the MEMS mirror elements fails to establish a specific emitter to a targeted receiver pairing, one can infer that that the receiver, emitter, or MEMS mirror elements may be bad. Fault isolation of the specific failing component can be easily achieved by using the repositionable capability of the MEMS mirror to further isolate the failing link.

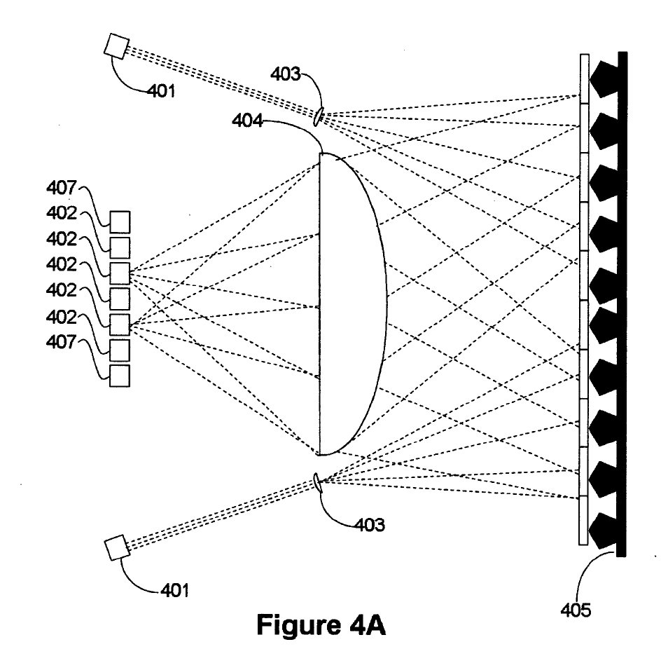

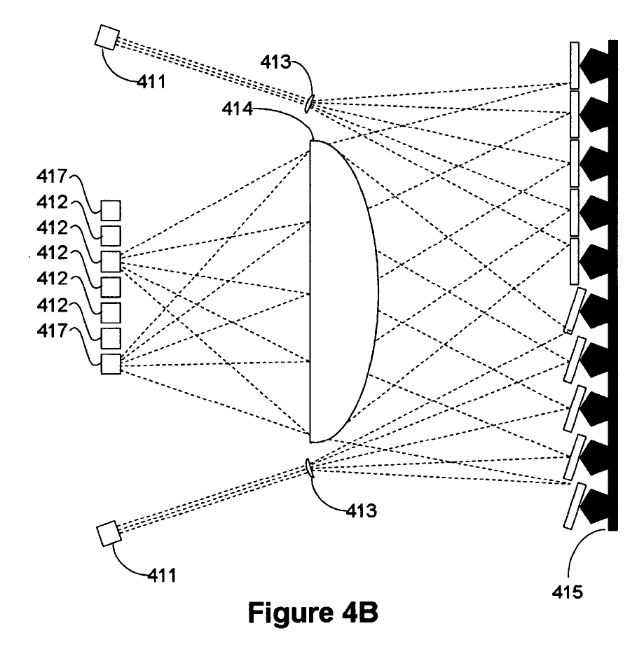

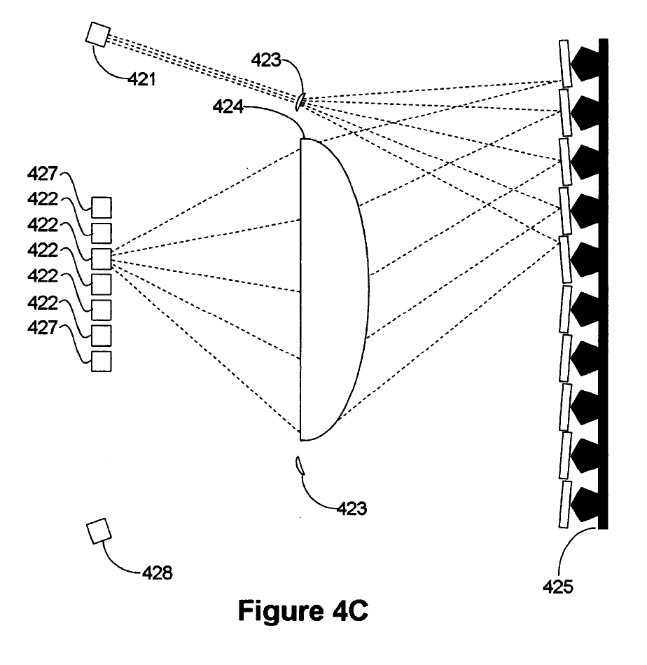

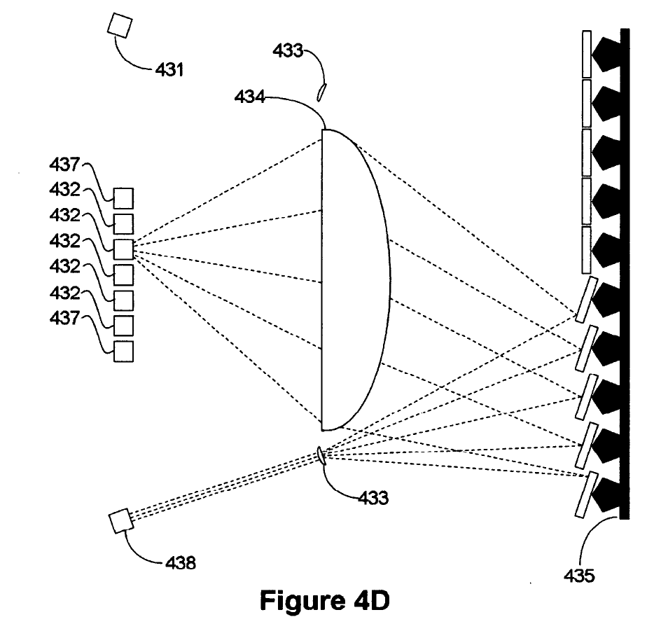

FIG. 4A shows a properly functioning free-space optical interconnect with redundant receivers 407. Emitter 401 transmits to spreading lens 403, bounces off MEMS mirror 405, through a focusing lens 404 to an optical receiver 402. Spare receivers 406 are available, but not required.

In FIG. 4B, an optical receiver 412 can be indirectly tested to see if it is bad by redirecting the emitter 411 to a spare receiver 417 and comparing results. The emitter beam 411, spreading lens 413 and focusing lens 414 operate normally, but the MEMS mirror 416 orthogonal reflection is adjusted to redirect the emitter's transmission from the intended receiver 412 in a X-Y grid to a spare receiver 417. If this is successful, the original receiver can be considered bad and taken offline for eventual replacement. The spare receiver can be mapped via software to become the new target receiver.

FIG. 4C shows a properly functioning free-space optical interconnect with redundant transmitters. Emitter 421 transmits to spreading lens 423, bounces of MEMS mirror 425, through a focusing lens 424 to an optical receiver 422. Spare receivers 427 and a spare transmitter 428 are available, but not required.

In FIG. 4D a transmitter 431 and MEMS mirror 435 element pair can be tested to see if they've failed by switching to a backup transmitter 438 and comparing results. A spare emitter 438 can have its corresponding MEMS mirror 435 element be orthogonally adjusted to target a specific receiver in the receiver array plane. In this example, the spare transmitter 438 sends it's transmission through the spreading lens 433 bounces off the repositioned MEMS mirror 435, through the focusing lens 434 to the original target receiver 432. If this is successful, the original emitter or the corresponding MEMS mirror elements can be considered bad and taken offline for eventual replacement. The spare emitter can be mapped via software to become the new emitter.

In FIG. 4D, if neither replacing the receiver 432, or emitter 431 and MEMS mirror 435 pair works, it can be inferred that multiple elements are broken and all three elements can be considered bad and taken offline for eventual replacement. A spare emitter 438, MEMS mirror 435 elements and receiver 437 can be remapped via software to become the new communication pair.

5. Reduction or Elimination of Optical Lenses in a Broadcast Optical Interconnect

The optical fan-out and broadcast interconnect described in United States Patent Application 2004/0156640 describes the use of spreading or splitting lens and focusing lenses to shape the optical transmissions within the communication interconnect. The use of a MEMS mirror configured into a steer-able, planar parabolic focusing mirror can replace some or all passive optical lenses in the communication interconnect. Removal of these splitting and focusing lenses can simplify manufacturing through reduced number of components and elimination of manual optical beam alignment requirements.

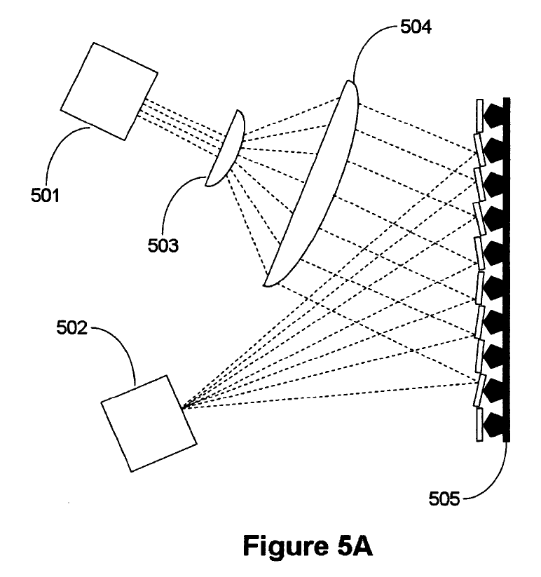

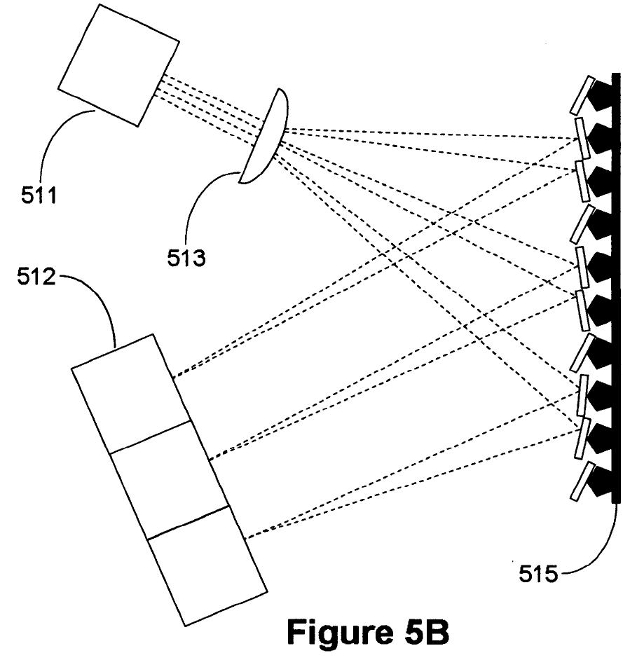

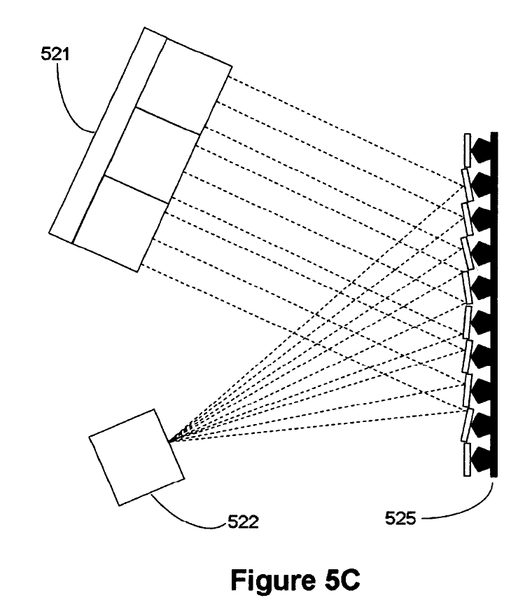

FIG. 5A describes how a focusing lens for the optical receiver 502 isn't required for the optical transmitter 501 that utilizes a spreading lens 503 and collimating lens 504 by reflecting off a correctly positioned MEMS mirror 505.

FIG. 5B describes how a focusing lens isn't required when a splitting lens 513 is used to communicate to an optical receiver array 512. The optical transmitter 511 has it's optical beam broken into n paths by a splitting lens 513, reflects the optical data transmission off the correctly positioned MEMS mirror 515 to the target receiver.

FIG. 5C describes a method to eliminate all lenses in an optical interconnect. A focusing lens isn't required for optical receiver 522 and a light shaping lens isn't required for a collimated light optical transmitter 521. This is accomplished by bouncing off the correctly positioned MEMS mirror 525.

The MEMS mirror can handle multiple transmitted light shaping lenses employed by those skilled in the art. A large number of planar parabolic mirrors could be implemented in a single MEMS mirror that has many thousands of configurable elements. The orthogonally reflected steering of the planar parabolic mirror elements to a specific receiver can be accomplished through a simple look-up table and real-time signal strength feedback techniques described in section 2 and failover technique for increased operational reliability as described in section 3.

6. MEMS Mirror Enabled Support for Array of Multiple Interconnects

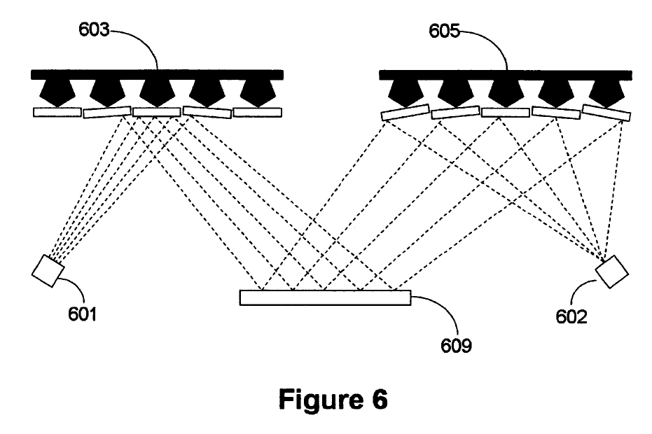

In configurations of the modular, broadcast, free-space interconnect that are manufacturing challenged by very large number of communication pairs due to the saturation of a MEMS mirror's available surface area FIG. 2A, multiple interconnect assemblies can be linked together FIG. 6. Bouncing optical transmitter 601, to a MEMS mirror 603, to a static mirror 609, to a second MEMS mirror 605 in a different interconnect to a receiver 602 in a different interconnect can easily increase the number of supported optical communication pairs. Multiple, loosely coupled interconnects ganged together also offer increased reliability as a significant portion of a single interconnect could fail without bringing down the aggregate, multi-unit, free-space optical interconnect.

The number of elements affecting the alignment of an optical signal hopping to multiple interconnects can easily triple the focusing requirements of a single interconnect. This can create a significant optical beam alignment challenge in both manufacturing tolerances and field replacement of failed components. Utilizing automatic focusing techniques described in this invention sections 2 and 4) can automate the alignment of the optical communication between multiple interconnects.

7. Real-Time or Static Support for Redundant Receivers

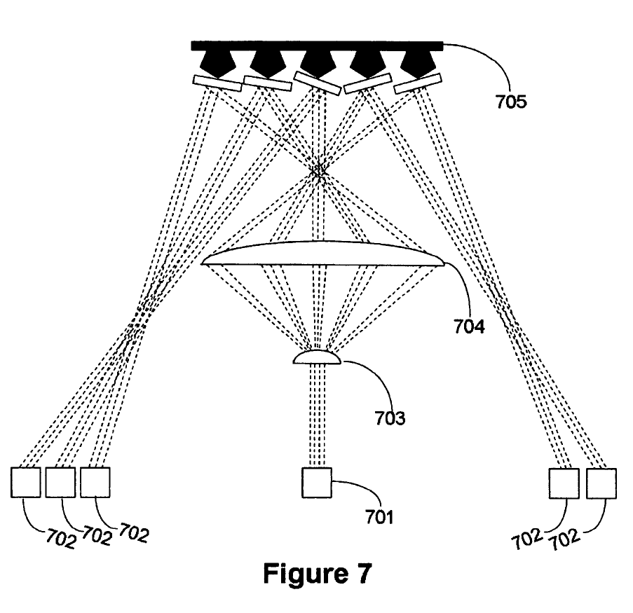

A free-space, optical broadcast interconnect in FIG. 7 shows a single optical emitter 701, spread the beam 703, directed or otherwise collimated beam 704, bounce off a MEMS mirror 705 and hit multiple receivers 702. This can be useful for real-time adjustment of the interconnect parameters to offer hot spare redundancy, pairing of channels for aggregate throughput improvement and traffic balancing support. This functionality can be provided without requiring the use of a splitting lens through the use of a MEMS mirror 705. The MEMS mirror also supports signal clean up, alignment and failover as previously described.

8. Electromechanical Substitution of a Failed MEMS Mirror

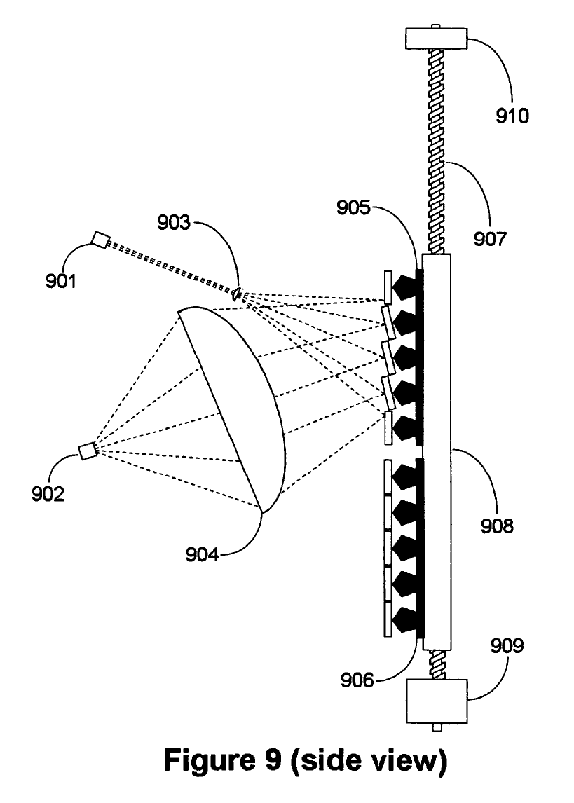

A free-space, optical broadcast interconnect with a spare MEMS mirror 906 is shown in FIG. 9. If the communication between an optical transmitter 901, that spreads the communication light through a spreading lens 903, bouncing of an aligned MEMS mirror 905, through a focusing lens 904 to an optical receiver 902 fails and can not be recovered by adjusting the position of the MEMS mirror elements, it can be inferred through software based diagnostics that MEMS mirror 905 may no longer be functioning as expected. A spare or plurality of MEMS mirror 906 can be moved into place of the failed MEMS mirror by means of a linear repositioning mechanism such as a threaded rod 907 being rotated by a servo motor 909 supported by a bearing block at the far end of the threaded rod 910. The failed MEMS mirror and backup mirror are both mounted to a base 908 that has been threaded to accept the rod 907. Once the new MEMS mirror is in place it can be adjusted to restore optically based communication as described in section 3 above

An embodiment of the invention can also be included in a kit-of-parts. The kit-of-parts can include some, or all, of the components that an embodiment of the invention includes. The kit-of-parts can be an in-the-field retrofit kit-of-parts to improve existing systems that are capable of incorporating an embodiment of the invention. The kit-of-parts can include software, firmware and/or hardware for carrying out an embodiment of the invention. The kit-of-parts can also contain instructions for practicing an embodiment of the invention. Unless otherwise specified, the components, software, firmware, hardware and/or instructions of the kit-of-parts can be the same as those used in an embodiment of the invention.

### Practical Applications

There are numerous manufacturing and usage benefits of including a MEMS mirror in a free-space, broadcast optical interconnect. Some of the usage benefits would be very pronounced in embedded or light-out facilities where an operator-less usage of the interconnect would greatly benefit from the self-healing capabilities presented by this invention.

A free-space, broadcast optical interconnect would be simpler to manufacture with a MEMS mirror replacing the static mirror for the following reasons:
1. Precise manufacturing alignment of transmitters, receivers, lenses and mirror is reduced or even eliminated through automatic programmatic configuration techniques.
2. Alignment of optical links between multiple interconnects is accomplished through automatic programmatic configuration techniques.
3. Physical redundancy of every part subject to failure in the optical interconnect isn't required for high-availability usages as a statistically calculated pool of spare components can be programmatically re-mapped into usage as required. A plurality of spare MEMS mirrors could also be electro-mechanically substituted for a failed MEMS mirror.

The functionality, performance & reliability of a free-space, broadcast optical interconnect would be improved with a MEMS mirror replacing the static mirror for the following reasons:
1. Alignment drift of the optical components can be adjusted in non-real-time in response to alignment errors caused by vibration, shock or temperature change.
2. Field replaced components in the optical interconnect can utilize programmatic optical alignment techniques instead of manual ones.
3. Greater failover support is provided through programmatically controlled redundancy or remapping of failed components to spares.
4. The interconnect can be programmatically reconfigured for asymmetric data throughput by allocating multiple optical channels for single high bandwidth data transfers.

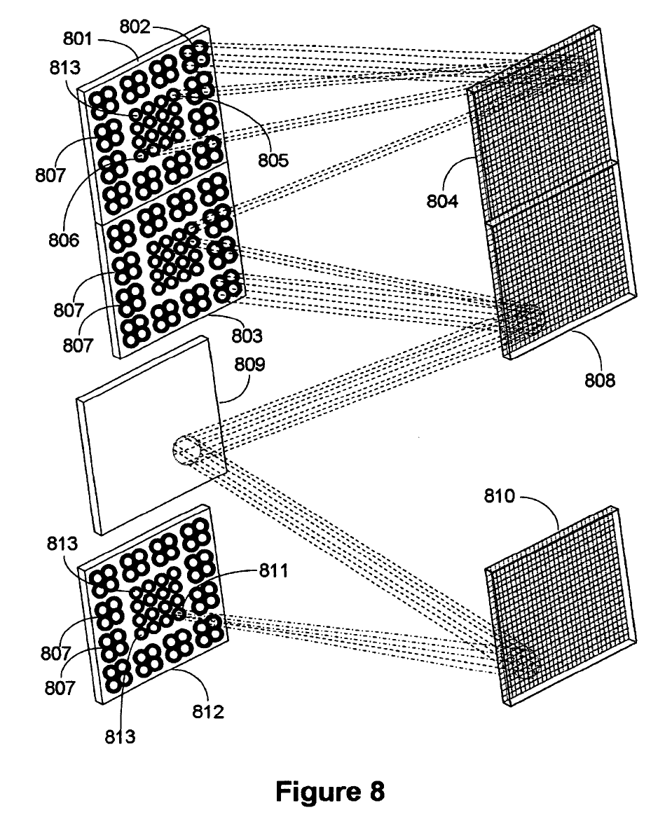

FIG. 8 shows a representative use of the preferred embodiment in a 16-way interconnect communicating with a separate 8-way interconnect. Co-planar transmitter and receiver arrays 801, 803 & 812 have spare transmitters 807 and receivers 813. Emitter array 802 sends an optical encoded communication beam to MEMS mirror 804 where the beam is split into three beams without a splitting lens. The split beams hit receivers 805, 806 on the same transmitter/receiver array 801 and to a third receiver on a 2^{nd} transmitter-receiver array 803 without a focusing lens. The 2^{nd} transmitter-receiver array 803 sends a collimated beam of light to it's corresponding MEMS mirror 808 which redirects the beam over to an external static mirror 809, on to the external interconnect's MEMS mirror 810 and finally to receiver 811 on the external interconnect's transmitter receiver array 812.

### Advantages

Embodiments of the invention can be cost effective and advantageous for at least the following reasons. Embodiments of the invention potentially provides at least nine advantages for a run-time repositionable Micro Electro Mechanical Systems (MEMS) mirror. The advantages of this invention include the following. Embodiments of the invention can provide multiple, optically-based communications sharing a single MEMS mirror. Embodiments of the invention can provide optical signal cleanup using a MEMS mirror. Embodiments of the invention can provide automated optical alignment with a MEMS mirror. Embodiments of the invention can provide broadcast optical interconnect component failover support. Embodiments of the invention can provide reduction or elimination of optical lenses in a broadcast optical interconnect. Embodiments of the invention can provide MEMS mirror enabled support for large interconnect arrays. Embodiments of the invention can provide real-time or static support for redundant receivers. Embodiments of the invention can provide the ability to swap out failed MEMS mirror with a spare one. Embodiments of the invention improve quality and/or reduce costs compared to previous approaches.

### Definitions

The term program and/or the phrase computer program are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically. The term proximate, as used herein, is intended to mean close, near adjacent and/or coincident; and includes spatial situations where specified functions and/or results (if any) can be carried out and/or achieved. The term distal, as used herein, is intended to mean far, away, spaced apart from and/or non-coincident, and includes spatial situation where specified functions and/or results (If any) can be carried out and/or achieved. The term deploying is intended to mean designing, building, shipping, installing and/or operating.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The phrase any integer derivable therein is intended to mean an integer between the corresponding numbers recited in the specification. The phrase any range derivable therein is intended to mean any range within such corresponding numbers. The term means, when followed by the term “for” is intended to mean hardware, firmware and/or software for achieving a result. The term step, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### Conclusion

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be formed in the disclosed shapes, or combined in the disclosed configurations, but could be provided in any and all shapes, and/or combined in any and all configurations. The individual components need not be fabricated from the disclosed materials, but could be fabricated from any and all suitable materials. Homologous replacements may be substituted for the substances described herein.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. An optical interconnect system comprising:
at least two processing elements, each of said processing elements comprising:
at least one optical signal transmitter;
at least one optical signal receiver on the same support structure as the transmitter; and
at least one MEMS mirror to provide the capability of optically connecting the emitter and transmitter.

2. The optical interconnect system of claim 1, wherein multiple optical signal reflections are spread across the surface of a MEMS mirror and unusable boundary areas between these signals are redirected to a light sink and discarded.

3. The optical interconnect system of claim 1, wherein marginal quality light beams on the periphery of a light based communication stream is redirected and disposed to an optical light sink

4. The optical interconnect system of claim 1 wherein signal strength of the optical reception of a transmitted optical signal is maximized algorithmically and through real-time signal strength feedback of the repositioning of a MEMS mirror.

5. The optical interconnect system of claim 4, wherein a pool of redundant optical transmitters, receivers MEMS mirror elements and remaps their subsequent use to substitutes for failed interconnect components.

6. The optical interconnect system of claim 5, wherein spreading, splitting and/or focusing lenses in a free-space optical interconnect is substantially eliminated.

7. The optical interconnect system of claim 6, wherein multiple MEMS mirrors and a static mirror on a different plane optically link multiple free-space optical interconnects together.

8. The optical interconnect system of claim 7, wherein a real-time ability to adjust the optical interconnect's performance characteristics is provided through the use of a MEMS mirror to split a signal into n-streams in order to handle peak data transfer loads, redundancy support for fail-over schemes and interconnect load balancing.

9. The optical interconnect system of claim 8, wherein a real-time ability to replace an entire failed MEMS mirror device is provided through automated electromechanical means.

10. A method comprising reconfiguring a free space broadcast interconnection including repositioning a micro electromechanical system mirror.

11. The method of claim 10, further comprising power-up initializing the free space broadcast interconnection before repositioning the micro electromechanical system mirror.

12. The method of claim 10, further comprising offline diagnosing the free space broadcast interconnection before repositioning the micro electromechanical system mirror.

13. The method of claim 10, further comprising responding to a runtime communication failure of the free space broadcast interconnection before repositioning the micro electromechanical system mirror.

14. The method of claim 10, wherein repositioning the micro electromechanical system mirror includes deforming a membrane of a deformable mirror.

15. The method of claim 10, wherein repositioning the micro electromechanical system mirror includes actuating a digital micro mirror device.
